(19) United States
(12) Patent Application Publication
(10) Pub. No.: US 2013/0031071 A1
(43) Pub. Date: Jan. 31, 2013

(54) CONTROL APPARATUS, CONTROL METHOD AND RECORDING MEDIUM OF CONTROL PROGRAM

(71) Applicants: Atsushi Shimano, Kawasaki (JP); Toshio Takeda, Machida (JP); Junichi Yamazaki, Mishima (JP); Shinya Suematsu, Yokohama (JP); Hiroshi Sasaki, Yokohama (JP); Shinya Echigo, Yokohama (JP); Takayuki Minato, Yokohama (JP); Tomohiro Kawasaki, Yokohama (JP); Yohei Kaneko, Kawasaki (JP)

(72) Inventors: Atsushi Shimano, Kawasaki (JP); Toshio Takeda, Machida (JP); Junichi Yamazaki, Mishima (JP); Shinya Suematsu, Yokohama (JP); Hiroshi Sasaki, Yokohama (JP); Shinya Echigo, Yokohama (JP); Takayuki Minato, Yokohama (JP); Tomohiro Kawasaki, Yokohama (JP); Yohei Kaneko, Kawasaki (JP)

(73) Assignee: FUJITSU LIMITED, Kawasaki-shi (JP)

(21) Appl. No.: 13/555,438

(22) Filed: Jul. 23, 2012

(30) Foreign Application Priority Data
Jul. 25, 2011 (JP) 2011-161863

(51) Int. Cl. G06F 17/30

(52) U.S. Cl. 707/705; 707/E17.001

(57) ABSTRACT

A control apparatus includes a memory, and a processor that executing a procedure, the procedure including, receiving a request corresponding to a file which is one of a plurality of files stored in a database server apparatus; in the case that the file corresponding to the request is stored in the memory, executing a process based on the request by using the file stored in the memory, and in the case that the file corresponding to the request is not stored in the memory, obtaining the file from the database server apparatus, storing the file in the memory, and processing the process by using the file.

### CROSS-REFERENCE TO RELATED APPLICATIONS

This application is based upon and claims the benefit of priority of the prior Japanese Patent Application No. 2011-161863, filed on Jul. 25, 2011, the entire contents of which are incorporated herein by reference.

### FIELD

The present invention relates to a computer, control method, and a recording medium of control program.

### BACKGROUND

An online system has application server apparatuses that perform processing according to a request from a client and send a response to the client that issued the request. Applications for processing requests are deployed previously in the application server apparatuses to process a request from a client.

Tens or hundreds of application server apparatuses are included in an online system and, as a request type is added, the applications have to be updated and added in each of the application server apparatuses. The update and addition are manually made by the administrator and they are very complicated.

When, for example, all applications are installed during introduction of application server apparatuses, it is sufficient to install them using a master disc including all the applications. Since the master disc is created at the initial installation, however, it does not support later updates of the applications. Accordingly, when an application server apparatus is additionally installed in an online system in which applications are frequently updated, to ensure the application server apparatus with the latest applications at that time, the applications have to be installed individually without using the master disc.

When, for example, all applications are installed during introduction of an application server apparatus, the online system has to be stopped temporarily in consideration of loads on the server apparatus and communication paths at the time of the update.

### SUMMARY

According to an aspect of the invention, a control apparatus includes a memory, and a processor that executing a procedure, the procedure including, receiving a request corresponding to a file which is one of a plurality of files stored in a database server apparatus; in the case that the file corresponding to the request is stored in the memory, executing a process based on the request by using the file stored in the memory, and in the case that the file corresponding to the request is not stored in the memory, obtaining the file from the database server apparatus, storing the file in the memory, and processing the process by using the file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an information processing system.

FIG. 2 illustrates an example of the hardware structure of an application server apparatus.

FIG. 3 is diagram 1 illustrating a table.

FIG. 4 illustrates an example of the hardware structure of a KVS.

FIG. 5 is diagram 2 illustrating a table.

FIG. 6 illustrates an example of the hardware structure of a RDB.

FIG. 7 is diagram 3 illustrating a table.

FIG. 8 illustrates flowchart 1 of processing by the application server apparatus.

FIG. 9 illustrates a flowchart of processing by the KVS.

FIG. 10 is diagram 4 illustrating a table.

FIG. 11 illustrates a flowchart of processing by the RDB.

FIG. 12 illustrates flowchart 2 of processing by the application server apparatus.

FIG. 13 illustrates flowchart 3 of processing by the application server apparatus.

### DESCRIPTION OF EMBODIMENTS

Preferred embodiments of the present invention will be explained with reference to accompanying drawings.

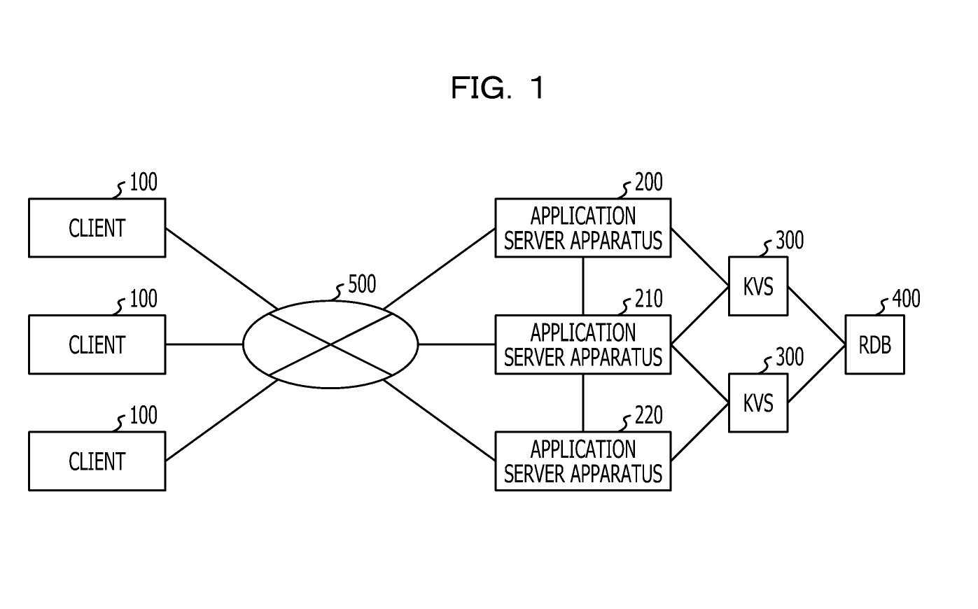

FIG. 1 schematically illustrates an information processing system according to an embodiment. The information processing system includes a plurality of clients 100, a network 500, application server apparatuses 200, 210, and 220, a plurality of KVSs (key value stores) 300, and a RDB (relational database) 400. The KVSs 300 are servers that manage data. The plurality of clients 100 are connected to the network 500. The application server apparatuses 200, 210, and 220 are also connected to the network 500. The application server apparatuses 200, 210, and 220 are connected to each other. The KVSs 300 are connected to the application server apparatuses 200, 210, and 220. The RDB 400 is connected to the KVSs 300.

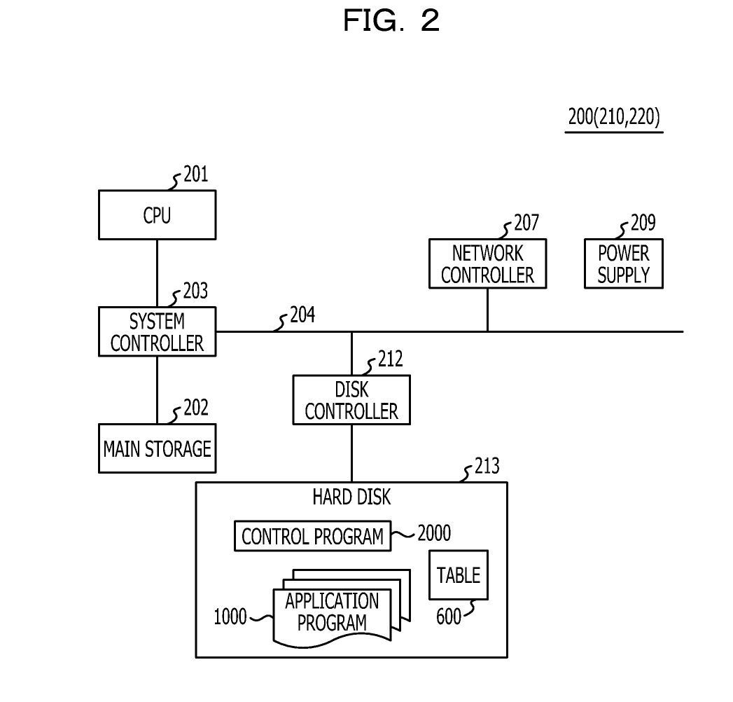

FIG. 2 is a block diagram schematically illustrating an example of the hardware structure of the application server apparatuses 200, 210, and 220 according to the embodiment. The application server apparatus 200 will be described below. The application server apparatus 200 will be described below as an example; in the embodiment, the application server apparatuses 210 and 220 are assumed to have the same structure as the application server apparatus 200.

The application server apparatus 200 processes a request received from the client 100. The application server apparatus 200 is controlled by a CPU (central processing unit) 201. The CPU 201 is an example of a processor used in the embodiment and the processor may be a MPU (micro processing unit).

A system controller 203 is connected to the CPU 201 and a main storage 202. The system controller 203 controls the data transfer between the CPU 201 and the main storage 202 and the data transfer between the CPU 201 and a bus 204. In addition, a network controller 207 and a disk controller 212 are connected to the system controller 203 through the bus 204.

The main storage 202 temporarily stores at least a part of an OS (operating system) program and an application program. The main storage 202 also stores various types of data to be used for processing by the CPU 201. As the main storage 202, for example, a RAM (random access memory) is used.

A hard disk 213 is connected to the disk controller 212.

The hard disk 213 stores a plurality of application programs 1000, which let the CPU 201 process a request from the OS or the client 100 in response to the request, a control program 2000, which lets the CPU 201 make control such as a call of the application programs 1000, and various types of data.

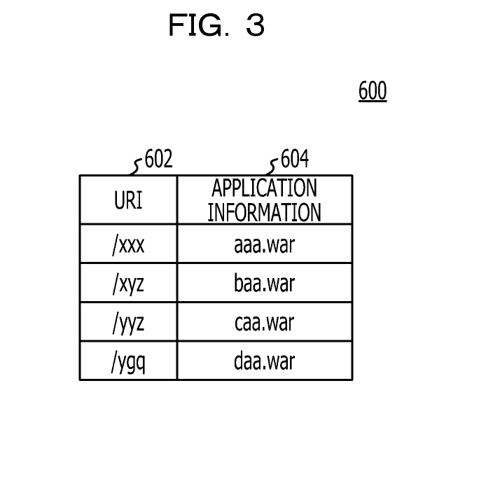

The hard disk 213 also stores a table 600, which contains uniform resource identifiers (URIs) 602 including the specification of the storage positions of applications and application information 604 of applications stored in the hard disk 213, as illustrated in FIG. 3. The application information 604 includes information that identifies an application, such as an application name.

The network controller 207 is connected to the network 500, which is illustrated in FIG. 1, and sends data to or receives data from the CPU 201, the hard disk 213, the client 100, another application server apparatus 200, and the KVS 300, through the network 500.

A power supply 209 supplies power to hardware components in the application server apparatus 200 through a power cable (not illustrated).

These hardware components achieve the processing functions of the application server apparatus 200.

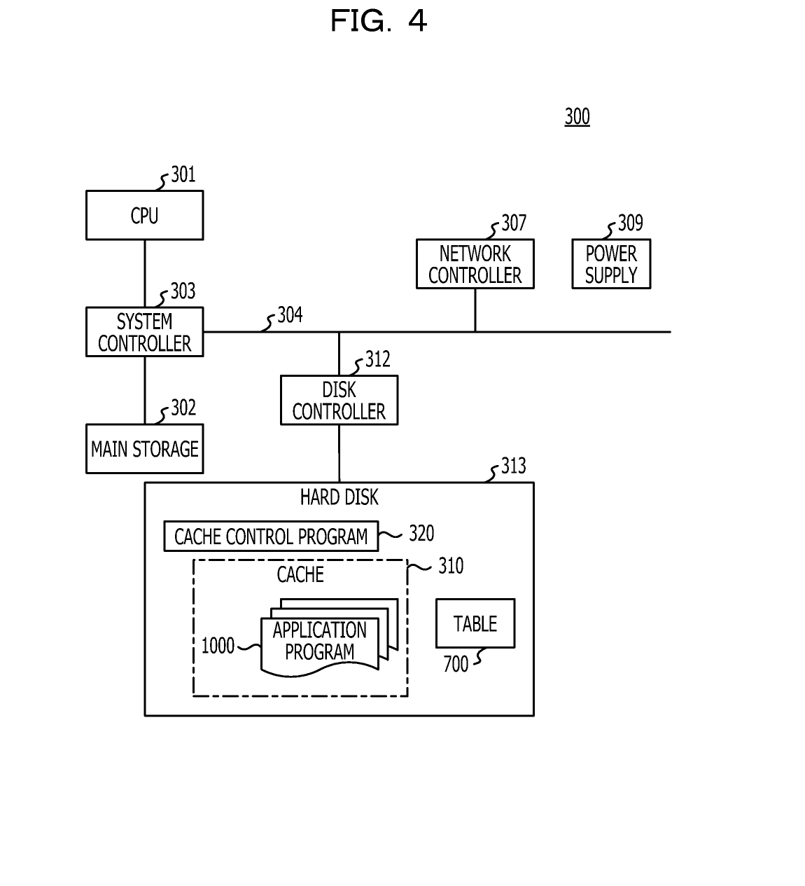

FIG. 4 is a block diagram schematically illustrating an example of the hardware structure of the KVS 300 according to the embodiment. The KVS 300 stores application programs executed by the application server apparatus 200. Since the blocks having the same name as in the application server apparatus 200 described with reference to FIG. 2 have the same functions, their descriptions will be omitted.

A hard disk 313 functions as a cache 310, which temporally stores the application programs 1000 executed by the application server apparatus 200, and stores a cache control program 320, which lets the CPU 301 control the cache 310.

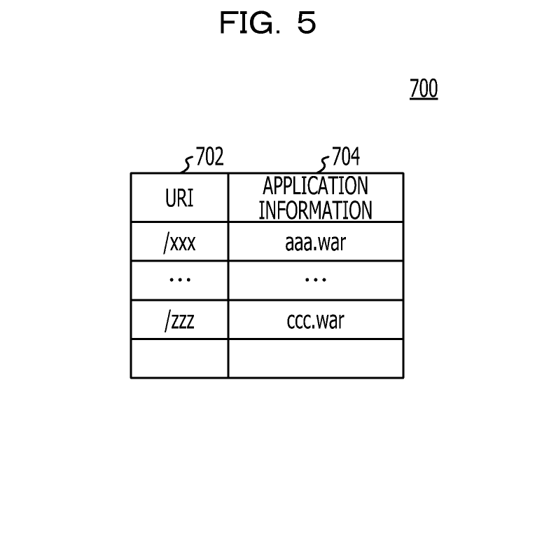

The hard disk 313 also stores a table 700 illustrated in FIG. 5, which records URIs 702 and application information 704 of the application programs 1000 that are temporally stored in the cache 310.

A network controller 307 sends data to or receives data from the CPU 301, the hard disk 313, application server apparatuses 200, 210, and 220, and the RDB 400.

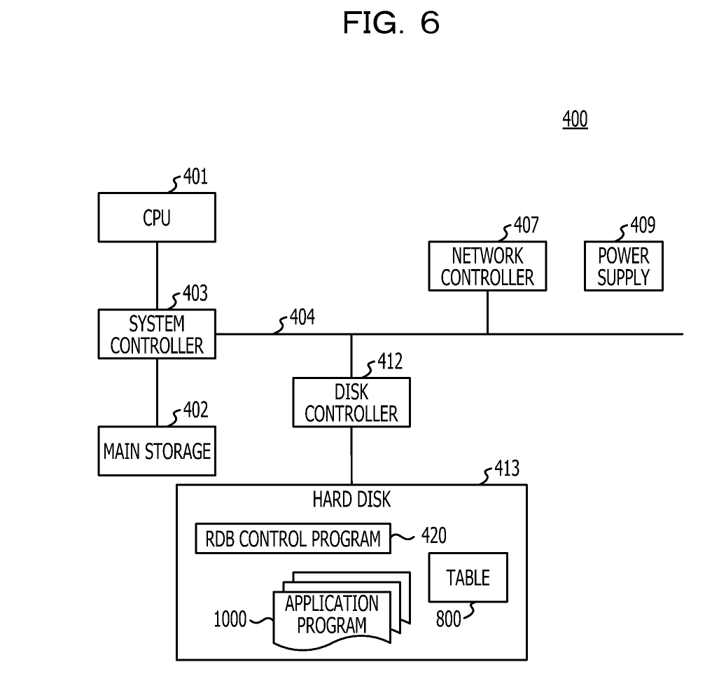

FIG. 6 is a block diagram schematically illustrating an example of the hardware structure of the RDB 400 according to the embodiment. The RDB 400 stores the plurality of application programs 1000 executed by the application server apparatuses 200, 210, and 220. Since the blocks having the same name as in the application server apparatus 200 described with reference to FIG. 2 have the same functions, their descriptions will be omitted.

A hard disk 413 stores the application programs 1000, which are executed by the application server apparatuses 200, 210, and 220, and an RDB control program 420, which lets a CPU 401 control the RDB 400.

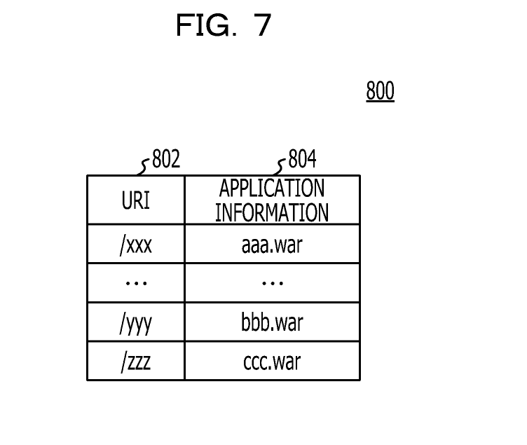

The hard disk 413 also stores a table 800. The table 800 records URIs 802 of the application programs 1000 stored in the hard disk 413 and application information 804 associated with the URIs 802, as illustrated in FIG. 7. A network controller 407 sends data to or receives data from the CPU 401, the hard disk 413, the application server apparatuses 200, 210, and 220, and the KVS 300.

The following describes processing by an online system according to the embodiment configured as described above.

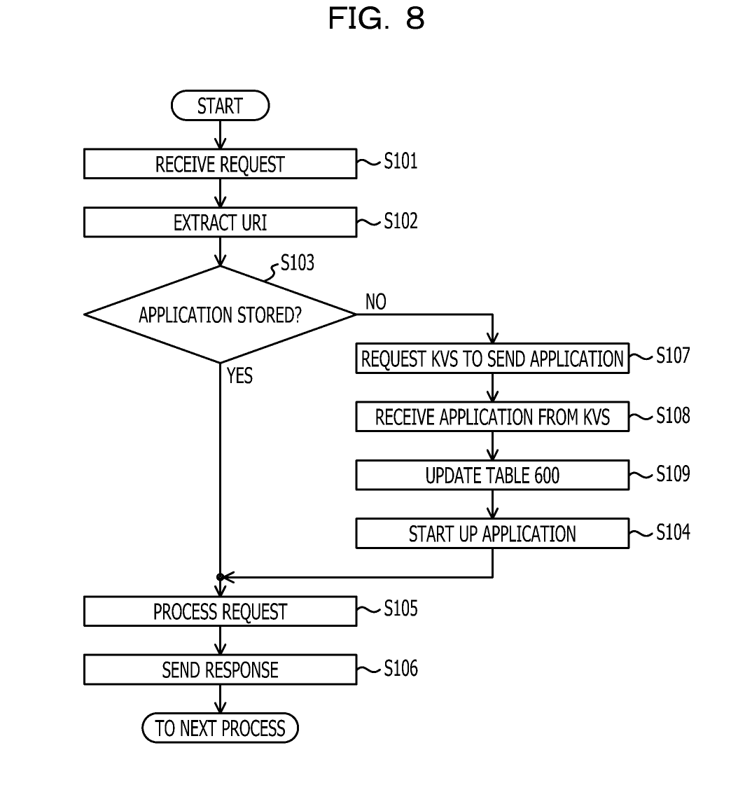

FIG. 8 illustrates a flowchart of processing by the application server apparatus 200 according to the embodiment. Unless otherwise specified, it is assumed that the CPU 201 performs the following processing by executing the control program 2000 stored in the hard disk 213. This flowchart illustrates processing by the application server apparatus 200; the application server apparatuses 210 and 220 are assumed to have the same structure as described above, so they perform the same processing as the application server apparatus 200, illustrated in this flowchart.

In S101, the CPU 201 receives a request from the client 100. The processing proceeds to S102.

In S102, the CPU 201 extracts a URI (uniform resource identifier) from the received request. The processing proceeds to S103.

In S103, the CPU 201 decides whether the application associated with the extracted URI is stored in the hard disk 213 with reference to the table 600 stored in the hard disk 213. As described above, the table 600 records the URIs 602 that the application server apparatus 200 stores in the hard disk 213 and the application information 604 associated with the URIs 602. When the application associated with the extracted URI is stored in the hard disk 213, the CPU 201 lets the processing proceed to S105. When the application associated with the extracted URI is not stored in the hard disk 213, the CPU 201 lets the processing proceed to S107.

It is assumed that the URI extracted by the CPU 201 in S102 is “/xxx”. Since the application “aaa.war” associated with the URI “/xxx” is recorded in the table 600, the CPU 201 decides that the application associated with the extracted URI is stored in the hard disk 213.

In S105, the CPU 201 loads the application “aaa.war” stored in the hard disk 213 into the main storage 202, executes it, and processes the request received from the client. The processing proceeds to S106.

In S106, the CPU 201 sends a response to the processed request to the client 100 through the network controller 207, ends the processing, and goes to the next process.

Next, the following describes the case where the application associated with the extracted URI is not stored in the hard disk 213 in S103 in FIG. 8.

It is assumed that the URI extracted by the CPU 201 in S102 is “/zzz”. Since the application associated with the URI “/zzz” is not recorded in the table 600, the CPU 201 decides that the application associated with the extracted URI is not stored in the hard disk 213. The processing proceeds to S107.

In S107, the CPU 201 sends the extracted URI “/zzz” to the KVS 300 through the network controller 207, requests the application associated with the URI “/zzz”, and lets the processing proceed to S108.

In S108, after requesting the application in S107, the CPU 201 receives the application “ccc.war” associated with the URI “/zzz” from the KVS 300 and stores the received application in hard disk 213. The processing proceeds to S109.

In S109, the table 600 is updated by adding the URI “/zzz” and application information “ccc.war” of the received application to the table 600. The processing proceeds to S104.

In S104 shifting from S109, the CPU 201 loads the application “ccc.war” stored in the hard disk 213 into the main storage 202 and executes it. The processing proceeds to S105.

In S105, the CPU 201 processes the request received from the client 100 by using the application “ccc.war” being executed in the main storage 202. The processing proceeds to S106.

In S106, the CPU 201 sends a response to the processed request to the client 100 through the network controller 207 and ends the processing.

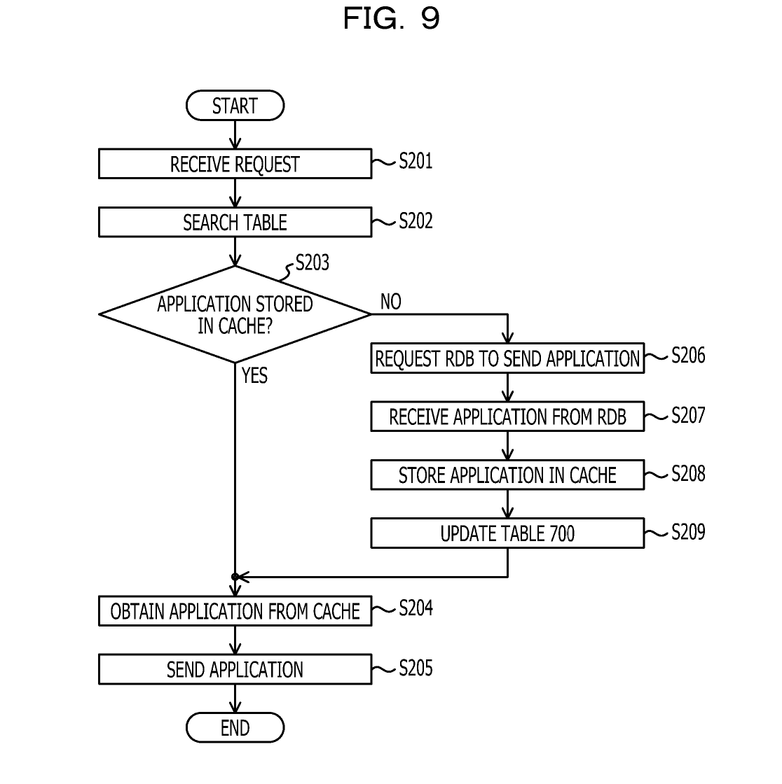

Next, processing by the KVS 300 will be described with reference to FIG. 9.

In S201, the CPU 301 receives the URI “/zzz” requested by the application server apparatus 200 in the processing in S107. The processing proceeds to S202.

In S202, the CPU 301 searches the table 700 stored in hard disk 313 by using the URI “/zzz” received from the application server apparatus 200. The processing proceeds to S203.

In S203, the CPU 301 decides whether the application associated with the received URI “/zzz” is stored in the hard disk 313 with reference to the table 700 stored in hard disk 313. The table 700 records the URIs 702 and the application information 704 associated with the URIs 702 as described above. When the application associated with the received URI is stored in the hard disk 313, the processing proceeds to S204. When the application associated with the extracted URI is not stored in the hard disk 313, the processing proceeds to S206. In this case, since the application “ccc.war” associated with the received URI “/zzz” is recorded in the table 700, the CPU 301 decides that the application associated with the received URI is stored in the hard disk 313. The processing proceeds to S204.

In S204, the CPU 301 obtains the application “ccc.war” associated with the received URI “/zzz” from the hard disk 313. The processing proceeds to S205.

In S205, the CPU 301 sends the obtained application “ccc.war” to the application server apparatus 200 through the network controller 307. The processing ends.

Next, the case where the application associated with the extracted URI is not stored in the hard disk 213 in S203 in FIG. 9 will be described. In the following description, it is assumed that the application server apparatus 200 requests the application associated with the URI “/yyy”.

In S201, the CPU 301 receives the URI “/yyy” from the application server apparatus 200. The processing proceeds to S202.

In S202, the CPU 301 searches the table 700 stored in the hard disk 313 by using the URI “/yyy” received from the application server apparatus 200. The processing proceeds to S203.

In S203, the CPU 301 decides whether the application associated with the received URI “/yyy” is stored in the hard disk 313 with reference to the table 700 stored in the hard disk 313. In this case, since the application associated with the received URI “/yyy” is not recorded in the table 700, the CPU 301 decides that the application associated with the received URI is not stored in the hard disk 313. The processing proceeds to S206.

In S206, the CPU 301 requests the application associated with the received URI “/yyy” by sending the URI “/yyy” to the RDB 400 through the network controller 307. The processing proceeds to S207.

Next, in S207, the CPU 301 receives the application “bbb.war” associated with the URI “/yyy” received from the RDB 400. The processing proceeds to S208.

In S208, the CPU 301 stores the received application “bbb.war” in the cache 310 of the hard disk 313. The processing proceeds to S209.

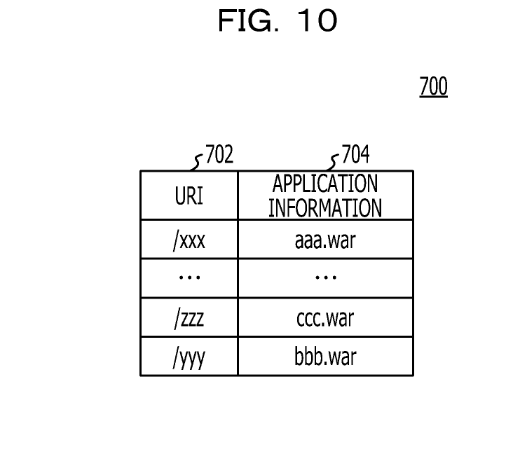

In S209, the CPU 301 associates the URI “/yyy” with the application “bbb.war”, adds the association in the table 700, and updates the table 700. FIG. 10 illustrates the updated table 700. The processing proceeds to S204.

In S204 shifting from S209, the CPU 301 obtains the application “ccc.war” associated with the URI “/zzz” received from the hard disk 313. The processing proceeds to S205.

In S205, the CPU 301 sends the obtained application “ccc.war” to the application server apparatus 200 through the network controller 307. The processing ends.

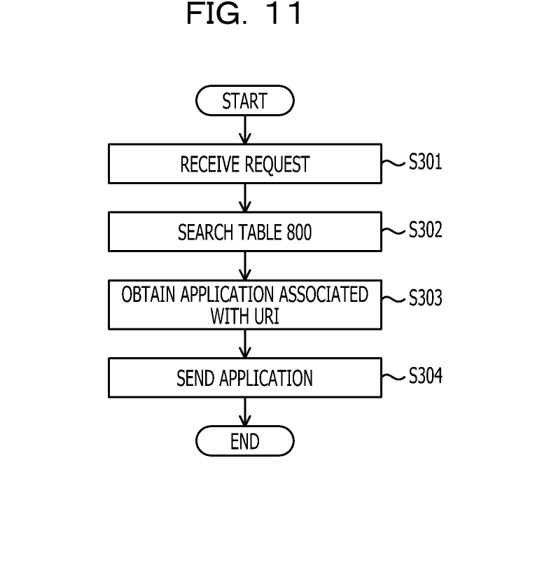

Next, processing by the RDB 400 will be described with reference to FIG. 11.

In S301, the CPU 401 receives the URI “/yyy” from the KVS 300. The processing proceeds to S302.

In S302, the CPU 401 searches the table 800 stored in the hard disk 413 by using the URI “/yyy” received from the KVS 300. The processing proceeds to S303.

In S303, the CPU 401 obtains the application associated with the received URI “/zzz” from the hard disk 413 with reference to the table 800 stored in the hard disk 413. In this case, since the application “bbb.war” associated with the received URI “/yyy” is recorded in the table 800, the CPU 401 obtains the application “bbb.war” associated with the received URI “/yyy” from the hard disk 413. The processing proceeds to S304.

In S304, the CPU 401 sends the obtained application “bbb.war” to the KVS 300 through the network controller 407. The processing ends.

As described above, according to the first embodiment, since the application server apparatus 200 deploys the application during reception of a request from the client 100, the application server apparatus 200 can process a request from the client 100 without previously deploying applications in each of the application server apparatuses 200, 210, and 220. Accordingly, the administrator does not have to deploy the applications at a time, thereby reducing the load on the administrator.

In addition, since the application server apparatus 200 installs only the application associated with a request when receiving the request, it does not have to install the application in the application server apparatus 200 at a time. This reduces a temporary increase in the network load caused by batch installation of applications and does away with temporary stop of the entire system.

In the flowchart illustrated in FIG. 11, there is not description on the process to be performed when the table 800 does not store application information. In this case, information indicating that there is no associated application is sent to the KVS 300 and the KVS 300 sends this information to the application server apparatus 200. After receiving this information, the application server apparatus 200 may return, to the client 100, information indicating that there is difficulty in processing this request.

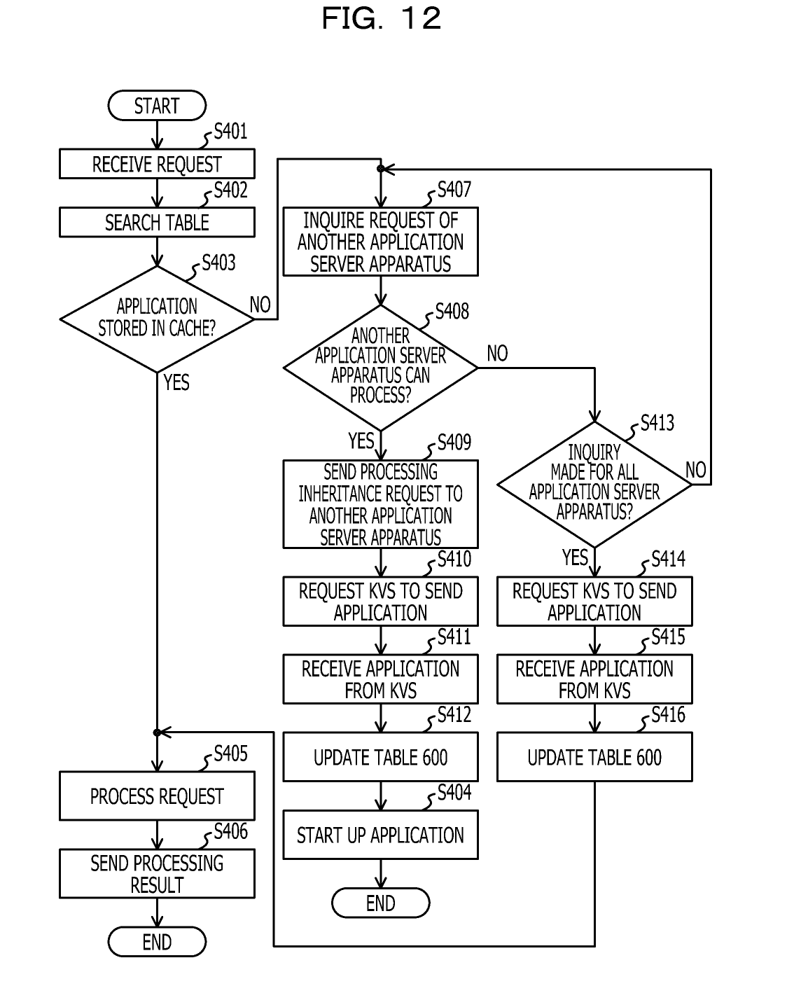

FIG. 12 is a flowchart illustrating processing by the application server apparatus 200 according to the embodiment.

In S401, the CPU 201 receives a request from the client 100. The processing proceeds to S402.

In S402, the CPU 201 searches the table 600 by using the URI extracted from the received request. The processing proceeds to S403.

In S403, the CPU 201 decides whether the application associated with the extracted URI is stored in the hard disk 213 with reference to the table 600 stored in the hard disk 213.

When the application associated with the extracted URI is stored in the hard disk 213, the processing proceeds to S405.

In S405, the CPU 201 starts up the associated application stored in the hard disk 213 and processes the request received in S401. The processing proceeds to S406.

In S406, the CPU 201 sends the result of the processing in S405 to the client 100.

When the CPU 201 decides that the application is not stored in the hard disk 213 in the processing in S403, the processing proceeds to S407.

In S407, the CPU 201 issues an inquiry to another application server apparatus 210 or 220 about the request received in S401 and receives a response from the application server apparatus. The processing proceeds to S408.

In S408, the CPU 201 decides whether the other application server apparatus 210 or 220 to which the inquiry has been issued can process the request based on the response received in S407. When the application server apparatus 210 or 220 can process the request, the processing proceeds to S409.

In S409, the CPU 201 sends an inheritance request to the other application server apparatus 210 decided to be able to process the request. More specifically, the CPU 201 sends the inheritance request, the request received from the client 100 in the processing in S401, address information for identifying the client 100, etc. The processing proceeds to S410.

In S410, the CPU 201 requests the KVS 300 for the application to be used for the processing in S401. The processing proceeds to S411.

In S411, the CPU 201 receives the application from the KVS 300, loads it, and stores it in the hard disk 213. The processing proceeds to S412.

In S412, the CPU 201 records the URI of the application obtained from the KVS 300 and application information in the table 600. The processing proceeds to S404.

In S404, the CPU 201 starts up the associated application stored in the hard disk 213. The processing ends.

That is, after inheriting the processing of a request for the other application, the CPU 201 installs and stores the application and updates the table 600 of the application, but the CPU 201 does not process the request.

Next, in S408, when the CPU 201 decides that the other application server apparatus 210 or 220 to which the inquiry has been issued is not able to process the request received in S401, the CPU 201 lets the processing proceed to S413.

In S413, the CPU 201 decides whether an inquiry has been issued to all application server apparatuses. When the CPU 201 decides that an inquiry has not been issued to all application server apparatuses, the CPU 201 lets the processing proceed to S407 and issues an inquiry to another application server apparatus to which an inquiry has not been issued. When the CPU 201 decides that an inquiry has been issued to all application server apparatuses, the CPU 201 lets the processing proceed to S414.

In S414, the CPU 201 requests the KVS 300 for the application to be used for the processing in S401. The processing proceeds to S415. In S415, the CPU 201 receives the application from KVS 300, loads it, and stores it in the hard disk 213. The processing proceeds to S416.

In S416, the CPU 201 stores the URI of the application obtained from the KVS 300 and application information in the table 600 and lets the processing proceed to S405.

If a transition to S414 is made in the processing in S413, it may not be possible for any of the other application server apparatuses to process the request. In this case, the CPU 201 installs the application in the application server apparatus 200 itself and performs processing as is.

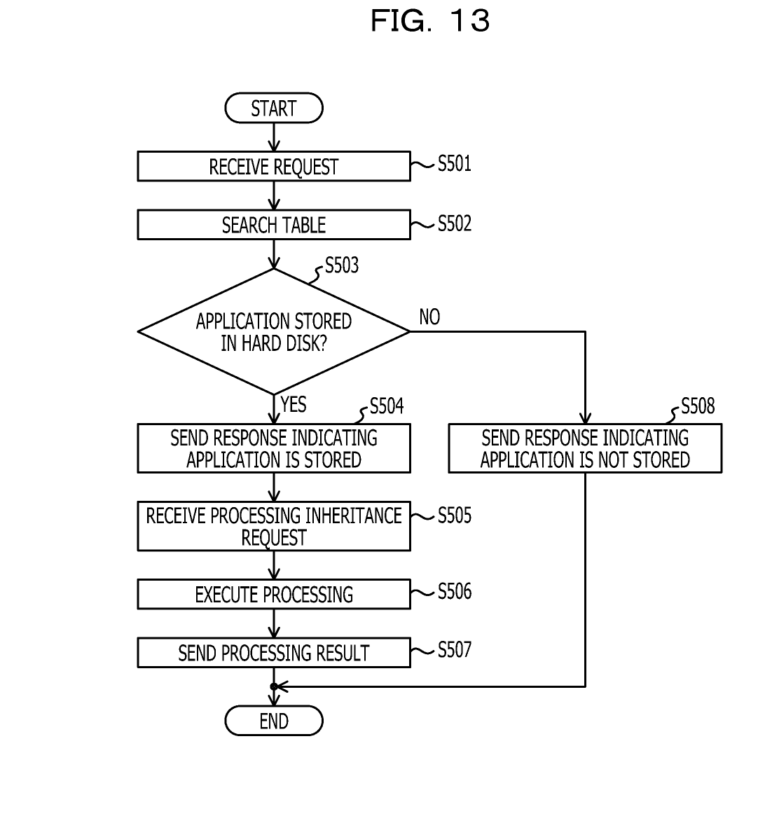

Next, in S407, the processing performed by the application server apparatus 210 that has received the inquiry sent by the application server apparatus 200 will be described with reference to FIG. 13.

In S501, the CPU 201 of the application server apparatus 210 receives the URI from the application server apparatus 200. The processing proceeds to S502.

In S502, the CPU 201 of the application server apparatus 210 searches the table 600 stored in the hard disk 213 of the application server apparatus 210 by using the URI received from the application server apparatus 200. The processing proceeds to S503.

In S503, the CPU 201 of the application server apparatus 210 decides whether the application associated with the received URI is stored in the hard disk 213 of the application server apparatus 210 with reference to the table 600 stored in the hard disk 213. When the application associated with the received URI is stored in the hard disk 213, the processing proceeds to S504. When the application associated with the extracted URI is not stored in the hard disk 213, the processing proceeds to S508.

In S508, the CPU 201 of the application server apparatus 210 sends, through the network controller 207, a response indicating that the application is not stored to the application server apparatus 200. The processing ends.

In S504, the CPU 201 of the application server apparatus 210 sends, through the network controller 207, a response indicating that the application is stored to the application server apparatus 200. The processing proceeds to S505.

In S505, the CPU 201 of the application server apparatus 210 receives a processing inheritance request from the application server apparatus 200. The processing proceeds to S506.

In S506, the CPU 201 of the application server apparatus 210 obtains the application associated with the received URI from the hard disk 213 of the application server apparatus 210 with reference to the table 600 stored in the hard disk 213, and performs processing based on a request from the client 100 included in the received inheritance information. The processing proceeds to S507.

In S507, the CPU 201 of the application server apparatus 210 sends, to the client 100, the result of the processing in S506 based on the address information of the client 100 included in the inheritance request received from the application server apparatus 200.

As described above, according to the second embodiment, the application server apparatus 200 receives the request from the client 100 and, if the application server apparatus 200 does not store the associated application and another application server apparatus can process the request, transfers the request received from the client to the other application server apparatus. That is, in the first embodiment, it is not possible to send the response to the client until the application is obtained and installed; in the second embodiment, since another application server apparatus processes the request, it is possible to save the time waiting for the application to be installed. In addition, since the appropriate application is stored in the application server apparatus 200, the next time a request to use the application is received, the application server apparatus 200 can process the request.

According to an aspect of the disclosed technology, the server apparatus deploys the application when receiving a request from a client, so the server does not have to previously deploy unnecessary applications. Therefore, the load on the system for deploying application can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus capable of accessing a database server apparatus that stores a plurality of files, the control apparatus comprising:
a memory; and
a processor that executes a procedure, the procedure including:
receiving a request corresponding to a file which is one of the plurality of files;
in the case that the file corresponding to the request is stored in the memory, executing a process based on the request by using the file stored in the memory; and
in the case that the file corresponding to the request is not stored in the memory, obtaining the file from the database server apparatus, storing the file in the memory, and processing the process by using the file.

2. The control apparatus according to claim 1, wherein
the memory further stores, for each file of the one or more files, storage information indicating the address in the database server apparatus of the each file and identification information identifying the each file; and
the procedure further includes:
deciding that the file is stored in the memory when the storage information of the file corresponding to the request and the identification information of the file are stored in the memory.

3. The control apparatus according to claim 1, wherein the procedure further includes:
in the case that the file is not stored in the memory, storing the storage information of the file corresponding to the request and the identification information of the file in the memory.

4. The control apparatus according to claim 1, wherein, when the file is not stored in the memory, the procedure further includes:
deciding whether file another computer connected to the computer stores the file; and
in the case that the another computer stores the file, having the another computer execute the process by using the file stored in the another computer.

5. The control apparatus according to claim 1, wherein each of the plurality of files is a program file of an application program.

6. A control method that causes a computer, which is capable of accessing a database server apparatus storing a plurality of files, to execute a procedure, the control method comprising:
receiving a request corresponding to a file which is one of the plurality of files;
in the case that the file corresponding to the request is stored in a memory of the computer, executing a process based on the request by using the file; and
in the case that the file corresponding to the request is not stored in the memory, obtaining the file from the database server apparatus, storing the file in the memory, and executing a process based on the request by using the files.

7. The control method according to claim 6, wherein the memory further stores, for each file of the one or more files, storage information indicating the address in the database server apparatus of the each file and identification information identifying the each file; the control method further comprising:
deciding that the file is stored in the memory when the storage information of the file corresponding to the request and the identification information of the file are stored in the memory.

8. The control method according to claim 6, further comprising:
in the case that the file is not stored in the memory, storing the storage information of the file corresponding to the request and the identification information of the file in the memory.

9. The control method according to claim 6, wherein, when the file is not stored in the memory, the control method further comprises:
deciding whether file another computer connected to the computer stores the file; and
in the case that the another computer stores the file, having the another computer execute the process by using the file stored in the another computer.

10. The control method according to claim 6, wherein each of the plurality of files is a program file of an application program.

11. A computer-readable recording medium storing a control program that causes a computer, which is capable of accessing a database server apparatus storing a plurality of files, to execute a procedure, the procedure comprising:
receiving a request corresponding to a file which is one of the plurality of files;
in the case that the file corresponding to the request is stored in a memory of the computer, executing a process based on the request by using the file; and
in the case that the file corresponding to the request is not stored in the memory, obtaining the file from the database server apparatus, storing the file in the memory, and executing a process based on the request by using the file.

12. The recording medium according to claim 11, wherein
the memory further stores, for each file of the one or more files, storage information indicating the address in the database server apparatus of the each file and identification information identifying the each file; and
the procedure further includes:
deciding that the file is stored in the memory when the storage information of the file corresponding to the request and the identification information of the file are stored in the memory.

13. The recording medium according to claim 11, the procedure further including:
in the case that the file is not stored in the memory, storing the storage information of the file corresponding to the request and the identification information of the file in the memory.

14. The recording medium according to claim 11, wherein, when the file is not stored in the memory, the procedure further includes:
deciding whether file another computer connected to the computer stores the file; and
in the case that the another computer stores the file, having the another computer execute the process by using the file stored in the another computer.

15. The recording medium according to claim 11, wherein each of the plurality of files is a program file of an application program.
